(19) United States
(12) Patent Application Publication
(10) Pub. No.: US 2010/0001441 A1
(43) Pub. Date: Jan. 7, 2010

(54) Brick Manufacturing Process Employing Cuttings of Geological Silts and Drillings Obtained From Drilling Operations

(76) Inventor: Veronica Tito, Buenos Aires (AR)

Correspondence Address: BOND, SCHOENECK & KING, PLLC, ONE LINCOLN CENTER, SYRACUSE, NY, 13202-1355, US

(21) Appl. No.: 12/498,697

(22) Filed: Jul. 7, 2009

(30) Foreign Application Priority Data
Jul. 7, 2008 (AR) P08 01 02922

(51) Int. Cl. C04B 33/132

(52) U.S. Cl. 264/641

(57) ABSTRACT

A procedure for manufacturing bricks from geological silts and drillings obtained from drilling operations is described, which comprises the step of mixing a volume of geological cuttings obtaining through the discarded material from the drilling of a well, such a as a water well, hydrocarbon prospecting, or any other fluid prospecting well. The geological cuttings are made of sands and geological clays, and they are then mixed in adequate proportions with commercial clays, fibrous organic material and water, until reaching the necessary plasticity allowing performing the subsequent molding operation with said mixture. The molded blocks and bricks thus obtained are then subjected to a baking thermal operation, obtaining desiccated bricks and blocks with the necessary mechanical resistance properties and hardness as required by a building material.

### REFERENCE TO RELATED APPLICATION

The present application claims priority to Argentinean Patent Application Serial Number P08 01 02922, filed Jul. 7, 2008, the entirety of which is hereby incorporated by reference.

### BACKGROUND

This instant invention relates generally procedure for the manufacture of bricks making use of geological silts and drillings as one of its manufacturing components. These silts and drillings result from the waste extracted by drilling operations of wells, such as water wells, petrol prospecting drilling, or the like.

Construction bricks or construction blocks, or even decorative bricks known in the building and decorative art, are usually manufactured from a mixture made of approximately 30% of fibers such as saw-dust or other vegetal fibers, and 70% of clays and water. Once a consistent mixture with these ingredients is obtained, capable to be molded in the required form and dimensions, such a dimensional standardization for constructions bricks, the molded pieces are subjected to a baking process with temperatures ranging from 800° C. to 1,200° C. Through this baking process the drying of each block or molded piece is obtained and its pasty condition is transformed into a hard brick or block of inert material.

Further, it is also known that the traditional well drilling operations, such as drilling operations for the purpose of creating water wells or prospecting sources of underground water, hydrocarbons or any other fluid, generates a volume of geological silt, sludge or drillings materials, also known as “cuttings” mainly made of sands and clays, roughly equivalent in volume to the drilled shaft of said well.

These geological silts and drillings are usually placed into repository pits or open pools, but in spite of fulfilling the actual Environmental Protection Acts requirements to preserve the media, they still generate a negative impact on the local ambient conditions (soil and air pollution, damage to the local fauna and vegetation).

These silt and drillings deposits, which at a given time when completed or filled must or should be adequately and safely disposed of, but the disposal procedure further adds new environmental challenges and costs.

It is therefore a principal object and advantage of the present invention to provide a method for employing these pollutant deposits as a constitutive part or component for the manufacture of bricks or blocks, transforming the residues into inert components.

Other objects and advantages of the present invention will in part be obvious, and in part appear hereinafter.

### SUMMARY OF THE INVENTION

In accordance with the foregoing objects and advantages, the present invention provides for the mixing of geological cuttings in adequate proportions with commercial clays and fibrous materials, depending on the origin and composition of said geological drilling, obtaining a mixture capable of being submitted to a baking process, rendering the resultant brick or block useful as construction or building material with adequate mechanical resistant properties.

Hence, the procedure of this invention, besides providing an industrial product suitable for employment in the construction of housing, buildings or the like, it is also an economic and final means of disposal of contaminant material, providing an end material of Inert components in an environmental ecologic-friendly manner.

As such it constitutes a useful tool for preserving and improving the endangered environment, collaborating with the sustainable development of industrial activities, helping to maintain a harmonic balance between nature and the industrial requirements, by means of avoiding the noxious accumulation of hazardous deposits, converting them into useful and inert material.

One novelty of the instant invention resides in the use of clays contained in these geological refuse deposits for the manufacture of bricks or blocks when mixed with other clays usually employed in the art, providing the necessary mechanical resistance characteristics of the end product for its use in the construction and building industry. Thus this geological refuse material is employed usefully, converting it into an inert construction or building material.

This invention is related to the manufacture of construction or building bricks or blocks making use of geological drillings or silt refuse material obtained from well drilling operations, prospecting for hydrocarbon wells, or the like.

As an alternative, the manufacture of these bricks or blocks may also be made from the domestic refuse of organic origin, which may also constitute an environment pollutant.

### DETAILED DESCRIPTION OF THE INVENTION

Upon the drilling of a well, the volume of the material extracted from said drilling is made of the several geological strata through which the drilling tool is passing. Whenever the drilled hole is cleared, or the corresponding tubing employed for the extraction of the seeked fluids take its place into said drilled hole, this volume of refuse has to be previously extracted from the drilling. Thus silt or refuse material also known as “cutting” in the appropriate technical language must be stored on the surface, usually at open air deposits.

These cuttings are made of sands, clays and calcareous or lime strata, varying in their proportions according to the different geological areas into which said drillings are performed. This amount of extracted refuse material or “cutting” is usually deposited into surface repositories or open-air pools, with a negative incidence on the surrounding environmental conditions.

This novel procedure includes the step of obtaining the geological cuttings from the open air deposits in which they are placed upon de well's drilling operation; provide to mix said cuttings with commercial clays, fibrous materials and water in a proportion ranging from 30% to 60% of this cutting deposit material. This mixture can be obtained at the same site of deposit of these cuttings, or otherwise, at the site in which the baking ovens are installed. This fibrous material provides the necessary bonding and homogeneous properties to the mixture to be baked.

Once said mixture attains the necessary plasticity to sustain the molding operation, preferably using moulds of standardized dimensions, said molded blocks or bricks are placed into an oven wherein they are subjected to a baking process with temperatures ranging from 800° C. to 1,200° C., until said molded objects are desiccated attaining the necessary mechanical properties such as hardness and resistance to compression which renders them useful for buildings and industrial use. This “plastic” condition of the paste is defined by its capacity to cling into the moulds and maintain a determined shape, prior to its baking process. Thus it is possible to obtain ornamental surfaces in each brick or block, such as reproducing the different textures, such as slate, etc.

The baking ovens may be fixed installations or mobile ovens.

As an alternative of this invention, the fibrous material of vegetal origin acting as a binder may be replaced by domestic refuse of organic nature of similar properties, providing the same bonding and homogeneity properties to the mixture to be baked. This mixture obtained with the organic refuse is then subjected to the same baking process as above mentioned.

### Preferred Examples Making Use of this Instant Invention

a) The silts or cuttings deposits are analyzed and separated in batches, according to their geological clays, lime and stone or hard deposits contents, according to pre-determined geological clay contents;

b) Once this classification is performed, the proportion of the geological clays is selected, according to the kind of bricks or blocks desired;

c) If the geological clays contents are not met according to the future bricks or blocks specifications, a dilution of the clays is performed until the admissible ranges are reached.

d) Once the geological clays contents are within the pre-arranged percentages, they are mixed into a uniform plastic paste which includes for each average 5.0 m³ of the final plastic paste:
3.5 to 4.0 m³ of geological cuttings;
0.5 to 1.0 m³ of surface earth (clays) or sands;
500 litres of saw dust (used as binder);
Water until said plastic conditions of the paste are met.

e) This paste is thoroughly blended along with the inclusion of the water contents until an uniform or homogenous paste is attained. The appropriate blending machines or devices are well known in the art.

f) Once this blend with the adequate plasticity is obtained, it is left to rest at open air, and/or water is added, until it has the optimum humidity, according to ambient factors.

g) After this, the paste is molded (bricks) or cut (blocks) according to the final product desired is obtained;

h) The molded or cut pieces are left on the ground to dissipate their humidity contents, and after this they are loaded into a baking oven to complete their drying process, at a temperature range between 900° C. to 1.000^{a}C in their respective nucleus, and 620^{a}C to 700^{a}c in their respective periphery, thus ensuring the reduction of any hydrocarbon contents.

i) The baked pieces are then left to cool and submitted to a contaminant substances test, to ensure the composition has the non aggressive characteristics.

This whole process will take from about 8 to 15 days.

What is claimed is:

1. A method for manufacturing bricks with use of geological silts and drillings obtained from drilling operations, comprising the following steps:
obtaining a provision of geological silts and drillings from the drilling of a well composed primarily of geological sands and clays, mixing said geological silts and drillings with commercial clays, fibrous substances of organic origin and water;
blending said mixture and adding water contents until reaching a predetermined plasticity and homogenous mixture, thereby allowing for placement of said mixture into pre-selected moulds to create molded material; and
subjecting said molded material to a thermal process wherein said molded material is desiccated, obtaining a corresponding number of bricks and blocks with the appropriate mechanical resistance and hardness properties suitable for their use in constructing.

2. The brick manufacturing process according to claim 1, wherein said fibrous material is of vegetal nature.

3. The brick manufacturing process according to claim 1, wherein said fibrous material is of an organic nature, obtained mainly from domestic and household refuses.

4. The brick manufacturing process according to claim 1, characterized by a means of elimination of a source of environmental pollution, converting said hazardous geological cuttings into an inert industrial product.
